(19) United States
(12) Patent Application Publication
(10) Pub. No.: US 2016/0170712 A1
(43) Pub. Date: Jun. 16, 2016

(54) Method for integrally implementing development and release of APP

(71) Applicant: Beijing Jinher Software Co., Ltd, Beijing (CN)

(72) Inventor: Runfeng LUAN, Beijing (CN)

(21) Appl. No.: 14/585,194

(22) Filed: Dec. 30, 2014

(30) Foreign Application Priority Data
Dec. 15, 2014 (CN) 201410779301.9

(51) Int. Cl. G06F 9/44; G06F 9/445

(52) U.S. Cl. CPC G06F 8/00; G06F 8/20; G06F 8/71; G06F 8/60

(57) ABSTRACT

The present invention relates to the technical field of computer application software, and in particular, to a method for integrally implementing development and release of an APP, including: configuring a main program template of the APP on an APP development platform, the main program template including a main program per se and a common component portion; configuring a configuration characteristic file module of the APP on the APP development platform, the configuration characteristic file module combining with the main program template to constitute the APP; and packaging the APP for a first time on the APP development platform; and sending an APP releasing request on an application release platform; the application release platform automatically examining the APP; after the examination is confirmed, packaging the APP for a second time, and packaging a tag of “examination confirmed” into the APP; and permitting release of the APP on the application release platform. Any user without any technical knowledge may produce a mobile phone APP of excellent quality according to his own creative idea, and the method is simple and fast, and with a low technical threshold.

### CROSS-REFERENCE TO RELATED APPLICATION

This application claims the priority benefit of Chinese patent application No. 201410779301.9, filed Dec. 15, 2014. The entirety of the above-mentioned patent application is hereby incorporated by reference herein and made a part of specification.

### TECHNICAL FIELD

The present invention relates to the technical field of computer application software, and in particular, to a method for integrally implementing development and release of an APP, and more specifically, to building a mobile application development and deployment platform based on the internet through the system and method, so that non-technical users and organizations may produce complicated, highly customized applications through the platform, and to enabling fast deployment or update of the produced applications to mobile devices cross platforms through the system and method.

### BACKGROUND

In recent years, the internet erupts with a lightning speed, and smart mobile phones are no exception. Business based on producing APP platforms is extremely active, scrambling to dig a pot of gold.

Mobile application developers represented by ios and android platforms are extraordinarily active, and an increasing number of people are hoping to create a miracle and initiate another new world with a single mobile APP.

However, such a miracle creators are limited to skilled programmers who are capable of programming. It is not so simple for an ordinary person to have an APP of his own. Nevertheless, the situation is about to be reversed, since the implementation of this platform makes a non-programming APP development possible, and anyone who desires to produce an APP may go through a few simple steps to develop an exquisite APP.

An APP self-development platform derives from broad market demands. The mobile internet experiences an evolvement from value-added telecommunication to the rise of WAP stations, and then to a later domination of native APPs. With development and popularization of smart mobile phones, native APPs will become the mainstream of future mobile internet. Since APPs are an newly emerging technology and modes, in the entire industry chain of mobile internet, development of APPs is still a section with a relatively large gap to market demands. Currently, most APP production companies in the market are operated in a way of outsourcing cooperation, that is, after clients and production companies have reached a cooperation agreement, the production companies develop, test, joint debug and test run according to requirements of the clients and deliver the final completed APP products to the clients.

The birth of the APP self-development platform satisfies the demand in evolvement of the internet from PC terminals to a mobile internet. For the mobile internet field with an excessively high technical threshold, the APP self-development platform may assist ordinary users to easily surmount the technical obstacles in developing a mobile phone APP. Any user without any technical knowledge may generate a native mobile phone APP of excellent quality according to his own creative idea, and the method is simple, fast, free and professional.

### SUMMARY

An objective of the present invention is to overcome a defect that currently a APP production period is long, and to provide a method for integrally implementing development and release of an APP.

A further objective of the present invention is to quickly package an android application or an ios application on an APP development platform by utilizing a replacement file.

A still further objective of the present invention is to automatically permit release of an APP on an application release platform after the examination is confirmed by utilizing an automatic examination.

In order to achieve the above objectives and other objectives of the present invention, technical solutions are provided by the present invention, as follows.

A method for integrally implementing development and release of an APP, including the following steps:

step 1, configuring a main program template of the APP on an APP development platform, the main program template including a main program per se and a common component portion;

step 2, further configuring a configuration characteristic file module of the APP on the APP development platform, the configuration characteristic file module combining with the main program template to constitute the APP; and packaging the APP for a first time on the APP development platform; and

step 3, sending an APP releasing request on an application release platform; the application release platform automatically examining the APP; after the examination is confirmed, packaging the APP for a second time, and packaging a tag of “examination confirmed” into the APP; and permitting release of the APP on the application release platform;

wherein, an android development tool which is installed on the APP development platform performs an android packaging operation on the main program template in advance, so that only the configuration characteristic file module is to be developed by a user; and after the development is completed, the android development tool performs an android packaging operation on the configuration characteristic file module developed by the user, and finally, results of the two packaging operations are combined to form a complete android packaged APP, as a result of the packaging for the first time.

Preferably, in the method for integrally implementing development and release of an APP, the application release platform automatically examining the APP, and contents of the examination includes: real-name authentication of an APP owner, a MAU index of the APP on internet, and an amount of contents in the APP, and after the above contents of the examination satisfy requirements, the application release platform judges that the examination is confirmed.

Preferably, in the method for integrally implementing development and release of an APP,

in the step 1, creating an APP by a developer logging on the APP development platform, and this includes:

a developer terminal which includes a PC terminal or a mobile phone terminal logging on the APP development platform, sending a producing request to the APP development platform, and the APP development platform returning a producing page to the developer terminal;

during the developer terminal develops an APP on the APP development platform, a database server storing address data of resource material used in configuration of resource material for the APP; a file server storing resource material files per se used in configuration of resource material for the APP; the address data of resource material including storing addresses of the resource material files in the file server;

an android packaging server receiving a developed APP, performing a packaging operation in an android format to form an apk file package, and transferring the packaged file to the file server and saving it in the file server;

an ios packaging server receiving a developed APP, performing a packaging operation in an ios format to form an ipa file package, and transferring the packaged file to the file server and saving it in the file server;

in the step 3, the application release platform receiving the packaged apk file package and/or ipa file package for release;

a user terminal selecting the APP to be downloaded on the application release platform, and the application release platform automatically selecting the apk file package or the ipa package according to a type of the user terminal, retrieving corresponding address data of resource material in the database server, automatically downloading a corresponding type of a file package in the file server according to the address data of resource material and configuring the resource material therein.

Preferably, in the method for integrally implementing development and release of an APP, during the APP development, the resource material files are firstly saved under a temporary file directory on the APP development platform, and after the APP is generated when the APP development is completed, the resource material files for the APP are then saved in the file server and the address data of the resource material files is saved in the database server.

Preferably, in the method for integrally implementing development and release of an APP, a database storing structure of the database server includes:

an APP basic information module, storing basic information needed in producing an APP;

a picture resource information module, storing download addresses and types of pictures needed in producing an APP;

a property application information module, storing properties and usages of resources needed in producing an APP;

an application package information module, storing fixed properties of packaging an APP after the production is completed;

an application status information module, storing a status during producing an APP;

a template type module, storing data indicating an APP type;

an application component module, storing information for a component having personalized features which is selectable to be loaded on an APP; and

a behavior information module, storing data that records using behavior of a user.

Preferably, in the method for integrally implementing development and release of an APP, the application status information module includes: in production, already produced, failed or on shelves, which is recorded as a current status of the APP.

According to another aspect of the present invention, the present invention also discloses a method for quickly packaging an android application or an ios application on an APP development platform, including the following steps:

step 1, configuring a main program template of the APP on the APP development platform, the main program template including a main program per se and a common component portion; and

step 2, further configuring a configuration characteristic file module and a plist replacement file of the APP on the APP development platform, the configuration characteristic file module combining with the main program template to constitute an android APP; the plist replacement file replacing a corresponding file in the program template to constitute a personalized ios APP;

wherein, only the plist replacement file is to be developed by a user, and after the development is completed, the plist replacement file replaces into the program template, and then an ios packaging operation is performed on the program template after replacement by utilizing a MAC OS system; and

wherein, an android development tool which is installed on the APP development platform performs an android packaging operation on the main program template in advance, so that only the configuration characteristic file module is to be developed by the user; and after the development is completed, the android development tool performs an android packaging operation on the configuration characteristic file module developed by the user, and finally, results of the two packaging operations are combined to form a complete android packaged APP.

Preferably, in the method for quickly packaging an android application or an ios application on an APP development platform,

in the step 1, configuring a main program template of the APP on the APP development platform, includes:

1) defining a name of the APP in a first text box;

2) generating a LOGO icon of the APP, displaying the LOGO icon on a mobile terminal which downloads and installs the APP, and generation modes of the LOGO icon including: uploading a picture of a corresponding size; or selecting an icon in a pure color from a candidate pool, and inputting a text which is presented on the icon in that color to form a picture of a corresponding size;

3) presenting a description of the APP in a second text box, and displaying the second text box on the application release platform at a position corresponding to where the APP is downloaded;

4) configuring a start interface of the APP, when the APP is started on a mobile terminal, displaying the start interface on the mobile terminal, and modes of configuring a start interface of the APP including: uploading a picture of a corresponding size; or selecting a picture of a corresponding size from a candidate pool;

5) configuring a skin of the APP in use, after the APP is started on a mobile terminal, skipping the start interface and displaying the skin on the mobile terminal as a background picture of the APP in use, and modes of configuring a skin of the APP in use including: selecting a corresponding skin from a candidate pool and the application release platform transforming the skin into the background picture of the APP in use according to a predetermined rule; and

6) configuring a layout of the APP, the layout being the layout of texts/pictures loaded on the background picture of the APP, and modes of configuring a layout of the APP including selecting a corresponding layout from a candidate pool.

Preferably, in the method for quickly packaging an android application or an ios application on an APP development platform,

in performing an android packaging operation on the configuration characteristic file module, firstly, loading all information of characteristic files into a memory of a server where the APP development platform is presented; the memory traversing all characteristic files one by one; and when each characteristic file is traversed, replacing original information data in the characteristic file with information data uploaded or selected by the user.

Preferably, in the method for quickly packaging an android application or an ios application on an APP development platform,

the common component portion contains a plurality of components, and they are selectively combined with the main program per se through selection of the user; and

the common component portion includes: a paying module, an instant communication module, an advertisement module, and/or a revenue module.

Preferably, in the method for quickly packaging an android application or an ios application on an APP development platform,

the main program per se includes: a graphic type of main program, a video type of main program, an electronic business type of main program and/or an audio type of main program.

Preferably, in the method for quickly packaging an android application or an ios application on an APP development platform, the information of the characteristic files is loaded into the memory in forms of nodes, and the memory accesses all the nodes one by one until it accesses a last node.

According to another aspect of the present invention, the present invention also discloses a method for integrally implementing development and release of APPs, including the following steps:

step 1, configuring main program templates of APPs on a first set of APP development platforms, the main program templates including main programs per se and common component portions; further configuring plist replacement files of the APPs on the APP development platforms, the plist replacement files replacing corresponding files in the program templates to constitute personalized APPs;

step 2, further configuring configuration characteristic file modules of the APPs on the first set of APP development platforms, the configuration characteristic file modules combining with the main program templates to constitute the APPs; and packaging the APPs for a first time on the APP development platforms; and

step 3, sending APP releasing requests on an application release platform; the application release platforms automatically examining the APPs; after the examinations are confirmed, packaging the APPs for a second time, and packaging tags of “examination confirmed” into the APPs; and permitting release of the APPs on the application release platform;

wherein, setting a predetermined number of the APPs which are simultaneously packaged for the first time on each development platform in the first set of development platforms;

receiving packaging requests of the APPs, performing packaging operations until APPs of the predetermined number are simultaneously packaged, and then performing queuing operation on the APPs which subsequently request for packaging;

transferring the APPs being packaged one by one to a second set of APP development platforms, and subsequently performing packaging operations on them; and each time when one APP being packaged is transferred, selecting one APP from the queued APPs to be supplemented to a group of the APPs being packaged on the first set of APP development platforms.

Preferably, in the method for integrally implementing development and release of APPs,

android development tools which are installed on the APP development platforms perform android packaging operations on the main program templates in advance, so that only the configuration characteristic file modules are to be developed by users; and after the developments are completed, the android development tools perform android packaging operations on the configuration characteristic file modules developed by the users, and finally, results of the two packaging operations are combined to form complete android packaged APPs;

wherein, only the plist replacement files are to be developed by the users, and after the developments are completed, the plist replacement files replace into the program templates, and then ios packaging operations are performed on the program templates after replacement by utilizing MAC OS systems.

Preferably, in the method for integrally implementing development and release of APPs, the method further includes:

developing a new function module in respect to a type of APP templates on an APP development platform;

selecting APPs of this type from released APPs, and packaging the selected APPs with the new function module in re-production of these APPs, and displaying them in gray;

if a user of an APP selects to upgrade it, selecting the APP displayed in gray which is with the new function module; and

if a user of an APP selects not to upgrade it, selecting the APP displayed in normal presentation which is not with the new function module.

The invention has the following advantageous effects:

1. the android development tool which is installed on the APP development platform may perform the android packaging operation on the main program template in advance, so that the user only needs to package the configuration characteristic file module, which is more intelligent and convenient, reducing packaging operations of the user and improving the packaging speed;

2. by realizing an automatic examination on whether a request for releasing an APP satisfies requirements, and automatically permitting release of the APP on the application release platform after the examination is confirmed, the problem that current manual operation has a relatively high error rate and is a waste of human resources, so the prevent invention has a good prospects, with a high efficiency, and is less prone to make a mistake;

3. the database storage structure of the APP development platform of the present invention achieves a unified management on configuration of information in producing an APP, and information of respective modules are fully recorded in producing the APP, which facilitates calling of information, and easily achieves APP production, modification, maintenance and management for non-programmer users;

4. users may produce a personalized APP by flexibly configuring data of basic description information, textual content information and picture resource information in the basic information module on the APP development platform, which is fast in production and easy for operation, and they may be stored in the database for APP modification, re-production, upgrading, maintenance and management by the user at any time;

5. the picture resource information module provides picture resources needed by the user in producing an APP, and the user may modify, re-produce, upgrade, maintain and manage APPs at any time, and the property application information module records a property and a usage of each resource, so the user may change the characteristics as desired, achieving characterized customization.

6. the application package information module records an access path and a relevant property of an installing package needed in producing an APP, to satisfy requirements from various platforms of ios and android;

7. the template type module records types of various APP products, covering demands from five main popular fields of graphics, electronic business, multimedia, enterprise gateway and social intercourse, and for each product, at least 10 templates of different styles may be selected, which enriches styles of the APPs;

8. any user without any technical knowledge may produce an excellent mobile phone APP according his own creative idea, which is simple and fast and imposes a low technical threshold;

9. personalized APPs may be customized, and the user may customize a name, a LOGO, a description, a starting interface, a skin and a layout of the APP, and the like, to satisfy various demands from the user, and the user may design his own APP according to his own idea;

10. in producing an APP, some data are stored in the database, which facilitates later modification, maintenance and management of the produced APP;

11. only a plist replacement file needs to be developed by the user, replaces into the program template, and then an ios packaging operation is performed on the program template after replacement by utilizing a MAC OS system, which is highly targeted, to reduce workload and improve the work efficiency;

12. a new function module may be developed on the APP development platform for the APP template, and displayed on the APP release platform in gray, which is convenient and fast;

13. a specific user terminal may be selected according to a user ID or a MAC code of the user terminal.

### BRIEF DESCRIPTION OF THE DRAWINGS

FIG. 1 is a flow chart showing a method for integrally implementing development and release of an APP according to the present invention; and

FIG. 2 is a flow chart showing a process of an application release platform automatically examining an APP according to the present invention.

### DETAILED DESCRIPTION

Hereinafter, the present invention is further described in detail in conjunction with accompany drawings, to enable those skilled in the art to practice the invention with reference to the contents of the description.

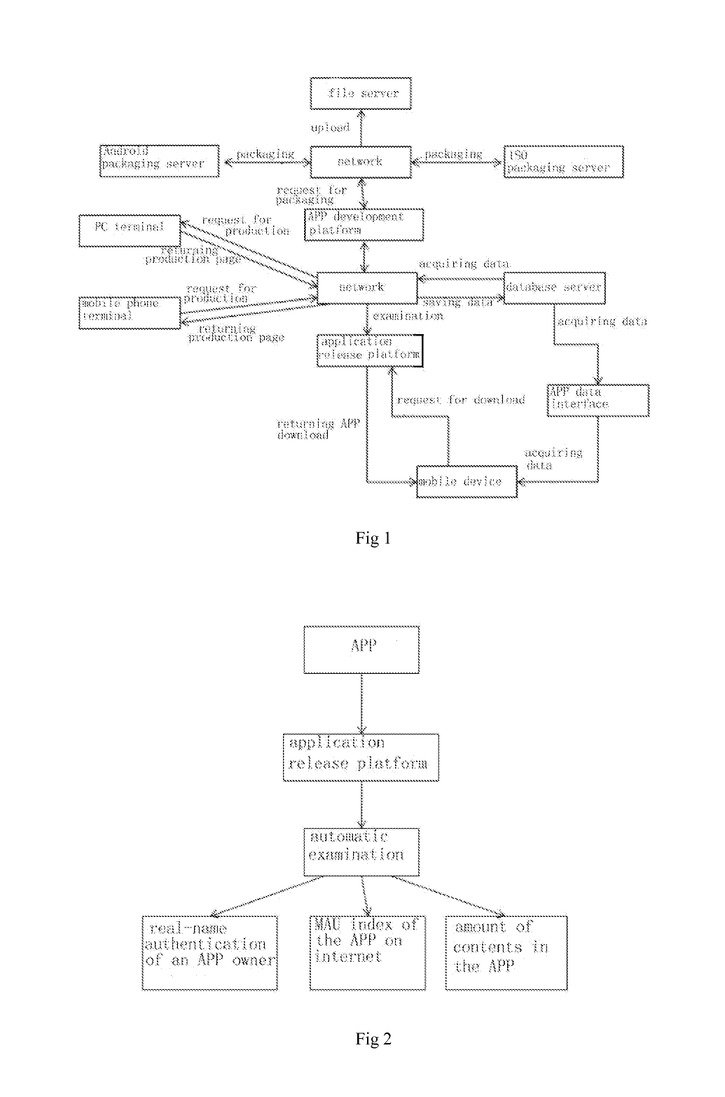

As shown in FIG. 1, a method for integrally implementing development and release of an APP, characterized in that, the method includes the following steps.

In step 1, in developing an APP, a developer firstly logs on an APP development platform, and configures a main program template of the APP on the APP development platform, and the main program template includes a main program per se and a common component portion. The main program per se includes: a graphic type of template such as a template for the Baidu group purchase, a video type of template such as a template for the Youku video or the QQ video, an electronic business type of template such as a template for the JD.com or the yhd.com and/or a social type of template such as a template for the QQ or the Wechat, for the developer to select according to a type of the APP to be developed. The common component portion contains common components for a same type of APPs developed by developers. For example, for group purchase APPs developed by developers, the common component portion contains common components such as a coupon component, a lottery component and a geographic location information component, from which the developers may select as desired.

In step 2, a configuration characteristic file module of the APP is further configured on the APP development platform. The configuration characteristic file module of the APP needs to be developed by the developer, and the developer develops the configuration characteristic file module as required by the APP to be developed. For example, for development of a configuration characteristic file module of a group purchase website, the developer needs to select a logo icon, a start background, a skin and the like for the APP to be developed. The developer combines the self-developed configuration characteristic file module and the main program template to constitute the APP, and packages the APP for a first time on the APP development platform by utilizing an android development tool. At this time, the APP packaged for the first time may be uploaded to any release platform to be released.

In step 3, after the first time of packaging is completed, if the developer intends to release the packaged APP to a release platform provided by the present inventor, the APP needs to be automatically examined. Conventional examination is conducted manually at a low speed and tends to make mistakes. In the present invention, an automatic examination is adopted to improve the speed of the examination and guarantee quality of the examination, reducing manual operations. After the first time of packaging is completed, the developer submits an APP release request on the application release platform, and the application release platform automatically examines the APP. After the examination is confirmed, the APP is packaged for a second time, in order to package a tag of “examination confirmed” into the APP. The release platform provided by the present inventor examines whether there is a tag of “examination confirmed” in the packaged document of the APP. If there is tag of “examination confirmed”, the APP is permitted to be released on the application release platform provided by the present invention; and if there is not, the APP is not permitted to be released on the application release platform provided by the present invention.

Wherein, an android development tool is installed on the APP development platform, and the android development tool performs an android packaging operation on the main program template in advance, in order to improve the packaging speed. This is because the main program template occupies the most part of the resources, while the configuration characteristic file module which is a modification to texts and pictures and has a small data amount, occupies only a small part of the resources. The main program template contains the common component portion, and this means the android development tool will package the common component portion when packaging the main program per se. For example, if the developer has selected 6 of 20 common components, the android development tool will package the 6 common components and combines the packaged common components with the packaged main program per se. The developer only needs to develop the configuration characteristic file module. After the development is completed, the android development tool performs an android packaging operation on the configuration characteristic file module developed by the user. Since the main program per se and the common component portion are packaged in advance, after the developer completes the configuration characteristic file module, the developer only needs to spend time to package the configuration characteristic file module, so that the packaging speed may be significantly improved. Finally, documents resulted from the two packaging operations are combined to form a complete android packaged APP, as a result of the packaging for the first time.

As shown in FIG. 2, in the method for integrally implementing development and release of an APP, the application release platform automatically examining the APP, and contents of the examination includes: real-name authentication of an APP owner, to prevent the developer sends out inappropriate information; a MAU index of the APP on the internet, to examine whether the APP has a value to be released by surveying the popularity of APPs of the developer on other platforms; and an amount of contents in the APP, to disconfirm the examination if a certain amount of content required by the examination procedure is not reached. After the above contents of the examination all satisfy the requirements, the application release platform judges that the examination is confirmed. By the automatic examination, the quality of APPs may be enhanced, and the speed of the examination may be improved compared to the manual examination.

In the method for integrally implementing development and release of an APP, in the step 1, the developer creates an APP by logging on the APP development platform, and this includes the following sub-steps.

When developing an APP, the developer may select a B/S architecture or a C/S architecture to develop the APP. Wherein, the B/S architecture is of a webpage form, which is relatively easy to be logged on and occupies a small space. While the C/S architecture is of a client terminal form, which accommodates more functions although is not so easy to be logged on. In case where the developer selects a mobile phone terminal, since the mobile phone has a limited capacity, the B/S architecture is normally selected to log on the APP development platform to release loads for the hardware of the mobile phone. In case where the developer selects a PC terminal, either of the B/S architecture and the C/S architecture may be selected to log on the APP development platform. If he selects the B/S architecture to log on the APP development platform, the developer needs to issue a producing request to the APP development platform. If the developer selects the C/S architecture, the APP development platform will return a specification for installation of a client terminal, the developer installs the client terminal according to the specification, and after the installation is completed, the developer may develop the APP.

During the developer terminal develops an APP on the APP development platform, according to the present invention, address data of resource material used in configuration of resource material for the APP is stored in a database server; and resource material files per se used in configuration of resource material for the APP are stored in a file server. The reasons for this is that, on one hand, the speed of retrieving the files or the addresses may be improved, and on the other hand, since the file server and the database server won't be shut down, it is guaranteed that the files or the addresses may be retrieved at any time. The address data of resource material and the resource material files per se may be stored in a cloud disc, on the internet or locally, however, since the files or the addresses will be managed at the place where the files or the addresses are stored, rather than by the platform provided by the present invention in retrieving the files or the addresses, the retrieving time period will be prolonged. Moreover, if the storage means is shut down, the files or the addresses may not be retrieved, which will cause significant inconvenience.

The address data of resource material includes storing addresses of the resource material files in the file server. The storing addresses are hierarchical relationship among textual information in the APP, basic description information of the APP, picture resource information and other information as well as serial numbers corresponding to each piece of information; and the file server stores the resource material files per se used in configuration of resource material for the APP, such as pictures, documents, audio and the like contained in the APP.

An android packaging server receives a developed APP, performs a packaging operation in an android format to form an apk file package, and transfers the packaged file to the file server and saves it in the file server.

An ios packaging server receives a developed APP, performs a packaging operation in an ios format to form an ipa file package, and transfers the packaged file to the file server and saves it in the file server.

In the step 3, the application release platform receives the packaged apk file package and/or ipa file package for release.

The android system and the ios system are systems most commonly used in the current market. Most mobile devices are using the android system since the android system is an open system which is less expensive, and the ios system is a system particularly for APPLE applications.

A user terminal selects the APP to be downloaded on the application release platform, and information about the selection is returned to the application release platform. At this time, the application release platform may read a property of the user terminal, and automatically selects the apk file package or the ipa package according to a type of the user terminal, an ios system or an android system for example. The selection information is returned to the database server, and the database server retrieves corresponding address data of resource material in the database server according to the returned information. Corresponding file package is searched out in the file server according to the address data of resource material and is automatically downloaded. All resource material in the downloaded file package is configured to be incorporated into a complete APP that is finally downloaded into a mobile device of the user.

In the method for integrally implementing development and release of an APP, during the APP development, the resource material files are firstly saved under a temporary file directory on the APP development platform until the first time of packaging is completed. And after that, the resource material files that have been packaged for the first time may be saved in the file server. Since the file server is a remote server, and needs to be accessed via network, if the resource material files are saved on the APP development platform, the files may be directly retrieved from the APP development platform so as to improve the packaging speed. For example, before the first time of packaging, the developer has used a picture A at a previous stage of the development of the APP, and replaced the picture A with a picture B, and if the picture A is stored under a temporary file directory on the APP development platform, the replacement may be directly performed on the APP development platform without transferring through a network, so as to save time for the replacement. The APP is generated after the APP development is completed, that is, after the first time of packaging is completed, the resource material files for the APP are then saved in the file server and the address data of the resource material files is saved in the database server.

In the method for integrally implementing development and release of an APP, a database storing structure of the database server includes:

an APP basic information module, storing basic information needed in producing an APP, including basic description information, textual content information and picture resource information, wherein, a user configures data in the APP basic information module for personalization on an APP production platform to produce an APP, which is fast in production and easy for operation, and the developer stores it in a database for modification, re-production, upgrading, maintenance and management of the APP at any time;

a picture resource information module, storing download addresses and types of pictures needed in producing an APP, including names, storing locations of pictures and correlations between APPs, and recording a property and a usage of each resource, wherein a user may change features and customize features thereof as desired;

a property application information module, storing properties and usages of resources needed in producing an APP, including logo resource marks, starting picture resource marks, skin resource marks and APP background resource marks, wherein in the example of a Baidu group purchase, an icon for the Baidu group purchase on a desktop of a mobile device is a logo resource mark, a picture displayed after the Baidu group purchase APP is started and before a main interface is entered is a starting picture resource mark, a uniform style of the main interface is a skin resource mark, and an icon corresponding to each menu among levels of menus in the main interface of the Baidu group purchase is an APP background resource mark;

an application package information module, storing fixed properties of packaging an APP after the production is completed, including an ID of the APP package, i.e. a serial number corresponding to the APP package, a type, i.e. ios or android, a download address of the APP package, a version number of the APP package, a password of the APP package, a signature of the APP package and a status of the APP package;

an application status information module, storing a status during producing an APP, including in production, already produced, failed or on shelves, which is recorded as a current status of the APP;

a template type module, storing data indicating an APP type, including a graphic type of template for a graphic type of APP, such as a group purchase APP, a multimedia type of template for a multimedia type of APP, such as a video APP, an electronic business type of template for an electronic business type of APP, such as an online shopping type of APP, and a social type of template for a social type of APP, such as a chat APP;

an application component module, storing information for a component having personalized features which is selectable to be loaded on an APP, including a name, an icon, a type and URL information recorded for the personalized component; and

a behavior information module, storing data that records using behavior of a user, wherein the behavior information module records using behavior of a user through a BR behavior coding function, including when the user uses the APP (rush hours used by the user found out by statistics), where the user uses the APP (for upgrading the APP according to different references of customs from different locations), through which MAC codes, domain names, websites and browsers the user uses the APP (for analyzing which browser the user prefers by statistics on the uses of the browsers, and for finding out the advantages and disadvantages of the browser by comparing two kinds of browsers).

A method for quickly packaging an android application or an ios application on an APP development platform, characterized in that, the method includes the following steps.

In step 1, in developing an APP, a developer firstly logs on an APP development platform, and configures a main program template of the APP on the APP development platform, and the main program template includes a main program per se and a common component portion. The main program per se includes: a graphic type of template such as a template for the Baidu group purchase, a video type of template such as a template for the Youku video or the QQ video, an electronic business type of template such as a template for the JD.com or the yhd.com and/or a social type of template such as a template for the QQ or the Wechat, for the developer to select according to a type of the APP to be developed. The common component portion contains common components for a same type of APPs developed by developers. For example, for group purchase APPs developed by developers, the common component portion contains common components such as a coupon component, a lottery component and a geographic location information component, from which the developers may select as desired. Wherein the common component portion is only for android development of APPs, and an ios APP program does not include a common component portion.

In step 2, a configuration characteristic file module and a plist replacement file of the APP is further configured on the APP development platform.

The configuration characteristic file module combines with the main program template to constitute an android APP. The plist replacement file replaces a corresponding file in the main program template to constitute a personalized ios APP. The plist replacement file contains developed an APP logo icon, a starting background, skins and the like.

Wherein, only the plist replacement file is to be developed by a user, and after the development is completed, the plist replacement file replaces into the program template, and then an ios packaging operation is performed on the program template after replacement by utilizing a MAC OS system. In ios packaging, the program per se may not be packaged in advance, and needs to be packaged together with the plist replacement file after the plist replacement file replaces into the program template. In this regard, the ios packaging is slower than android packaging.

Wherein, an android development tool which is installed on the APP development platform performs an android packaging operation on the main program template in advance, so that only the configuration characteristic file module is to be developed by the user; and after the development is completed, the android development tool performs an android packaging operation on the configuration characteristic file module developed by the user, and finally, results of the two packaging operations are combined to form a complete android packaged APP.

In the method for quickly packaging an android application or an ios application on an APP development platform, in the step 1, to develop an ios application, firstly, a main program template of the APP is configured on the APP development platform, including:

1) defining a name of the APP in a first text box, for example, to develop a group purchase website, a name “Baidu Nuomi” of the group purchase website to be entered on the APP development platform;

2) generating a LOGO icon of the APP, displaying the LOGO icon on a mobile terminal which downloads and installs the APP, for example, an icon of “Baidu Nuomi” displayed on a mobile phone, and generation modes of the LOGO icon including: uploading a picture of a corresponding size; or selecting an icon in a pure color from a candidate pool, and inputting a text which is presented on the icon in that color to form a picture of a corresponding size;

3) presenting a description of the APP in a second text box, and displaying the second text box on the application release platform at a position corresponding to where the APP is downloaded, for example, for a baby nurturing APP, an introduction of contents, functions and the like of the baby nurturing APP presented in the second text box for a user, before he downloads the APP, to review and to select whether to download it;

4) configuring a start interface of the APP, when the APP is started on a mobile terminal, displaying the start interface on the mobile terminal, and modes of configuring a start interface of the APP including: uploading a picture of a corresponding size; or selecting a picture of a corresponding size from a candidate pool;

5) configuring a skin of the APP in use, after the APP is started on a mobile terminal, skipping the start interface and displaying the skin on the mobile terminal as a background picture of the APP in use, and modes of configuring a skin of the APP in use including: selecting a corresponding skin from a candidate pool and the application release platform transforming the skin into the background picture of the APP in use according to a predetermined rule; and

6) configuring a layout of the APP, the layout being the layout of texts/pictures loaded on the background picture of the APP, for example, for a layout of a group purchase APP, a picture with a text below it and another picture below the text, and modes of configuring a layout of the APP including selecting a corresponding layout from a candidate pool.

In the method for quickly packaging an android application or an ios application on an APP development platform, the developer develops and uploads personalized configuration characteristic files, and in performing an android packaging operation on the personalized configuration characteristic file module, firstly, all information of personalized configuration characteristic files is loaded into a memory of a server where the APP development platform is presented; the memory traverses all the existing configuration characteristic files in the server one by one; and when each configuration characteristic file is traversed, replacing original information data in the characteristic file in the memory of the server with information data uploaded or selected by the user.

In the method for quickly packaging an android application or an ios application on an APP development platform, the common component portion contains a plurality of components, and they are selectively combined with the main program per se through selection of the user; and the common component portion includes: a paying module, an instant communication module, an advertisement module, and/or a revenue module.

In the method for quickly packaging an android application or an ios application on an APP development platform, the main program per se includes: a graphic type of main program such as a template for the Baidu group purchase, a video type of main program such as a template for the Youku video or the QQ video, an electronic business type of main program such as a template for the JD.com or the yhd.com and/or an audio type of main program such as a template for the Cool Dog Music.

In the method for quickly packaging an android application or an ios application on an APP development platform, the information of the characteristic files is loaded into the memory in forms of nodes, and the memory accesses all the nodes one by one until it accesses a last node.

A method for integrally implementing development and release of APPs, the method includes the following steps:

In step 1, there are two types of programs for the developer to select to develop an application. One is an android program and the other is an ios program. According to which program the developer selects, templates may be selected on the APP development platform provided by the present invention. Firstly, main program templates of APPs are configured on a first set of APP development platforms of the present invention, wherein the main program templates includes main programs per se and common component portions. Wherein, the main programs per se are used in android programs and ios programs, and the common component portions are used for developing android programs only. Plist replacement files of the APPs are further configured on the APP development platforms, and the plist replacement files replaces corresponding files in the program templates to constitute personalized APPs. The plist replacement files are for development of ios programs only.

In step 2, configuration characteristic file modules of the APPs are further configured on the first set of APP development platforms, and the configuration characteristic file modules combines with the main program templates to constitute the APPs. In developing android programs for APPs, packages the APPs for a first time on the APP development platform by utilizing android development tools, and at this time, the APPs packaged for the first time may be uploaded to any release platform to be released. In developing ios programs for APPs, after the development of plist replacement files are completed, the plist replacement files replace into the program templates, and then ios packaging operations are performed on the program templates after replacement by utilizing a MAC OS system, as the first time of packaging.

In step 3, after the first time of packaging is completed, if the developer intends to release the packaged APPs to release platforms provided by the present inventor, the APPs needs to be automatically examined. Conventional examination is conducted manually at a low speed and tends to make mistakes. In the present invention, an automatic examination is adopted to improve the speed of the examination and guarantee quality of the examination, reducing manual operations. After the first time of packaging is completed, the developer submits an APP release request on the application release platform, and the application release platform automatically examines the APPs. After the examinations are confirmed, the APPs are packaged for a second time, in order to package tags of “examination confirmed” into the APPs. The release platforms provided by the present inventor examine whether there are tags of “examination confirmed” in the packaged documents of the APPs. If there are tags of “examination confirmed”, the APPs are permitted to be released on the application release platforms provided by the present invention; and if there are not, the APPs are not permitted to be released on the application release platforms provided by the present invention.

Wherein, a predetermined number of the APPs which are simultaneously packaged for the first time is set on each development platform in the first set of development platforms, for example, the predetermined number is set as 100 on the first set of development platforms.

Packaging requests of the APPs are received, packaging operations are performed until APPs of the predetermined number are simultaneously packaged, and then queuing operation on the APPs which subsequently request for packaging are performed. For example, in the present invention, if the first server needs to perform a function updating operation on APPs, and the first set of development platforms set a predetermined number for packaging as 100, when a number of packaging reaches 100, the 101th and the subsequent documents to be packaged are performed with queuing operation.

The APPs being packaged are transferred one by one to a second set of APP development platforms, and packaging operations are subsequently performed on them. For example, if the 101th document to be packaged is queuing, a document being packaged on the first set of packaging platforms is transferred to the second set of APP development platforms, and the 101th document to be packaged is transferred to the first set of APP development platforms. Then the next document being packaged on the first set of packaging platforms is transferred to the second set of APP development platforms, and the 102th document that is waiting to be packaged is transferred to the first set of APP development platforms, and so on. And each time when one APP being packaged is transferred, one APP from the queued APPs is selected to be supplemented to a group of the APPs being packaged on the first set of APP development platforms. Two sets of APP development platforms are provided for the following reasons, one is that the waiting time in packaging queue may be shortened, and the other is that when one of the APP development platforms needs updating and maintenance, documents being packaged on the APP development platform that needs maintenance may be transferred one by one to the other set of APP development platforms in order to keep the packaging operations running without stop.

In the method for integrally implementing development and release of APPs, android development tools which are installed on the APP development platforms perform android packaging operations on the main program templates in advance, so that only the configuration characteristic file modules are to be developed by users; and after the developments are completed, the android development tools perform android packaging operations on the configuration characteristic file modules developed by the users, and finally, results of the two packaging operations are combined to form complete android packaged APPs; and

wherein, only the plist replacement files are to be developed by the users, and after the developments are completed, the plist replacement files replace into the program templates, and then ios packaging operations are performed on the program templates after replacement by utilizing MAC OS systems.

In the method for integrally implementing development and release of APPs, the method further includes:

developing a new function module in respect to a type of APP templates on an APP development platform. For example, an APP development platform of the present invention develops a new function for the type of APPs. APPs of this type are selected from released APPs. The selection is for the reason that the developed new function module is still in a test stage, and may have some defects to be improved. Selection of APPs is to find on the development platform some APPs as test users on the development platform. For example, there are 10,000 APPs of the type, APPs of test users that participated at an early stage are found out on the APP development platform. For example, there are 100 APP developers of the type of APPs desires to be test users, and the 100 APPs are selected to be re-produced to APPs with the new function module. The 100 APPs are presented on the templates in gray, such that the users of these APPs will see them presented in gray at the client terminals. The remaining APPs are not upgraded, and displayed on the APP development platform in normal state. The 100 APPs selected to be upgraded are packaged as APPs with the new function module in re-production, and displayed in gray, wherein the new function module is added into the main programs.

If a user of an APP selects to upgrade it, selecting the APP displayed in gray which is with the new function module; and

if a user of an APP selects not to upgrade it, selecting the APP displayed in normal presentation which is not with the new function module.

Although the embodiments of the present invention have been disclosed as above, they are not limited merely to those set forth in the description and the embodiments, and they may be applied to various fields suitable for the present invention. For those skilled in the art, other modifications may be easily achieved without departing from the general concept defined by the claims and their equivalents, and the present invention is not limited to the particular details.

What is claimed is:

1. A method for integrally implementing development and release of an APP, characterized in that, the method comprises the following steps:
step 1, configuring a main program template of the APP on an APP development platform, the main program template comprising a main program per se and a common component portion;
step 2, further configuring a configuration characteristic file module of the APP on the APP development platform, the configuration characteristic file module combining with the main program template to constitute the APP; and packaging the APP for a first time on the APP development platform; and
step 3, sending an APP releasing request on an application release platform; the application release platform automatically examining the APP; after the examination is confirmed, packaging the APP for a second time, and packaging a tag of “examination confirmed” into the APP; and permitting release of the APP on the application release platform;
wherein, an android development tool which is installed on the APP development platform performs an android packaging operation on the main program template in advance, so that only the configuration characteristic file module is to be developed by a user; and after the development is completed, the android development tool performs an android packaging operation on the configuration characteristic file module developed by the user, and finally, results of the two packaging operations are combined to form a complete android packaged APP, as a result of the packaging for the first time.

2. The method for integrally implementing development and release of an APP of claim 1, characterized in that, the application release platform automatically examining the APP, and contents of the examination comprises: real-name authentication of an APP owner, a MAU index of the APP on internet, and an amount of contents in the APP, and after the above contents of the examination satisfy requirements, the application release platform judges that the examination is confirmed.

3. The method for integrally implementing development and release of an APP of claim 2, characterized in that,
in the step 1, creating an APP by a developer logging on the APP development platform, and this comprises:
a developer terminal which comprises a PC terminal or a mobile phone terminal logging on the APP development platform, sending a producing request to the APP development platform, and the APP development platform returning a producing page to the developer terminal;
during the developer terminal develops an APP on the APP development platform, a database server storing address data of resource material used in configuration of resource material for the APP; a file server storing resource material files per se used in configuration of resource material for the APP; the address data of resource material comprising storing addresses of the resource material files in the file server;
an android packaging server receiving a developed APP, performing a packaging operation in an android format to form an apk file package, and transferring the packaged file to the file server and saving it in the file server;
an ios packaging server receiving a developed APP, performing a packaging operation in an ios format to form an ipa file package, and transferring the packaged file to the file server and saving it in the file server;
in the step 3, the application release platform receiving the packaged apk file package and/or ipa file package for release;
a user terminal selecting the APP to be downloaded on the application release platform, and the application release platform automatically selecting the apk file package or the ipa package according to a type of the user terminal, retrieving corresponding address data of resource material in the database server, automatically downloading a corresponding type of a file package in the file server according to the address data of resource material and configuring the resource material therein.

4. The method for integrally implementing development and release of an APP of claim 3, characterized in that, during the APP development, the resource material files are firstly saved under a temporary file directory on the APP development platform, and after the APP is generated when the APP development is completed, the resource material files for the APP are then saved in the file server and the address data of the resource material file is saved in the database server.

5. The method for integrally implementing development and release of an APP of claim 3, characterized in that, a database storing structure of the database server comprises:
an APP basic information module, storing basic information needed in producing an APP;
a picture resource information module, storing download addresses and types of pictures needed in producing an APP;
a property application information module, storing properties and usages of resources needed in producing an APP;
an application package information module, storing fixed properties of packaging an APP after the production is completed;
an application status information module, storing a status during producing an APP;
a template type module, storing data indicating an APP type;
an application component module, storing information for a component having personalized features which is selectable to be loaded on an APP; and
a behavior information module, storing data that records using behavior of a user.

6. The method for integrally implementing development and release of an APP of claim 5, characterized in that, the application status information module comprises: in production, already produced, failed or on shelves, which is recorded as a current status of the APP.

7. A method for quickly packaging an android application or an ios application on an APP development platform, characterized in that, the method comprises the following steps:
step 1, configuring a main program template of the APP on the APP development platform, the main program template comprising a main program per se and a common component portion; and
step 2, further configuring a configuration characteristic file module and a plist replacement file of the APP on the APP development platform, the configuration characteristic file module combining with the main program template to constitute an android APP; the plist replacement file replacing a corresponding file in the program template to constitute a personalized ios APP;
wherein, only the plist replacement file is to be developed by a user, and after the development is completed, the plist replacement file replaces into the program template, and then an ios packaging operation is performed on the program template after replacement by utilizing a MAC OS system; and
wherein, an android development tool which is installed on the APP development platform performs an android packaging operation on the main program template in advance, so that only the configuration characteristic file module is to be developed by the user; and after the development is completed, the android development tool performs an android packaging operation on the configuration characteristic file module developed by the user, and finally, results of the two packaging operations are combined to form a complete android packaged APP.

8. The method for quickly packaging an android application or an ios application on an APP development platform of claim 7, characterized in that,
in the step 1, configuring a main program template of the APP on the APP development platform, comprises:
1) defining a name of the APP in a first text box;
2) generating a LOGO icon of the APP, displaying the LOGO icon on a mobile terminal which downloads and installs the APP, and generation modes of the LOGO icon comprising: uploading a picture of a corresponding size; or selecting an icon in a pure color from a candidate pool, and inputting a text which is presented on the icon in that color to form a picture of a corresponding size;
3) presenting a description of the APP in a second text box, and displaying the second text box on the application release platform at a position corresponding to where the APP is downloaded;
4) configuring a start interface of the APP, when the APP is started on a mobile terminal, displaying the start interface on the mobile terminal, and modes of configuring a start interface of the APP comprising: uploading a picture of a corresponding size; or selecting a picture of a corresponding size from a candidate pool;
5) configuring a skin of the APP in use, after the APP is started on a mobile terminal, skipping the start interface and displaying the skin on the mobile terminal as a background picture of the APP in use, and modes of configuring a skin of the APP in use comprising: selecting a corresponding skin from a candidate pool and the application release platform transforming the skin into the background picture of the APP in use according to a predetermined rule; and
6) configuring a layout of the APP, the layout being the layout of texts/pictures loaded on the background picture of the APP, and modes of configuring a layout of the APP comprising selecting a corresponding layout from a candidate pool.

9. The method for quickly packaging an android application or an ios application on an APP development platform of claim 7, characterized in that,
in performing an android packaging operation on the configuration characteristic file module, firstly, loading all information of characteristic files into a memory of a server where the APP development platform is presented; the memory traversing all characteristic files one by one; and when each characteristic file is traversed, replacing original information data in the characteristic file with information data uploaded or selected by the user.

10. The method for quickly packaging an android application or an ios application on an APP development platform of claim 7, characterized in that,
the common component portion contains a plurality of components, and they are selectively combined with the main program per se through selection of the user; and
the common component portion comprises: a paying module, an instant communication module, an advertisement module, and/or a revenue module.

11. The method for quickly packaging an android application or an ios application on an APP development platform of claim 7, characterized in that,
the main program per se comprises: a graphic type of main program, a video type of main program, an electronic business type of main program and/or an audio type of main program.

12. The method for quickly packaging an android application or an ios application on an APP development platform of claim 7, characterized in that, the information of the characteristic files is loaded into the memory in forms of nodes, and the memory accesses all the nodes one by one until it accesses a last node.

13. A method for integrally implementing development and release of APPs, characterized in that, the method comprises the following steps:
step 1, configuring main program templates of APPs on a first set of APP development platforms, the main program templates comprising main programs per se and common component portions; further configuring plist replacement files of the APPs on the APP development platforms, the plist replacement files replacing corresponding files in the program templates to constitute personalized APPs;
step 2, further configuring configuration characteristic file modules of the APPs on the first set of APP development platforms, the configuration characteristic file modules combining with the main program templates to constitute the APPs; and packaging the APPs for a first time on the APP development platforms; and
step 3, sending APP releasing requests on an application release platform; the application release platforms automatically examining the APPs; after the examinations are confirmed, packaging the APPs for a second time, and packaging tags of “examination confirmed” into the APPs; and permitting release of the APPs on the application release platform;
wherein, setting a predetermined number of the APPs which are simultaneously packaged for the first time on each development platform in the first set of development platforms;
receiving packaging requests of the APPs, performing packaging operations until APPs of the predetermined number are simultaneously packaged, and then performing queuing operation on the APPs which subsequently request for packaging;
transferring the APPs being packaged one by one to a second set of APP development platforms, and subsequently performing packaging operations on them; and each time when one APP being packaged is transferred, selecting one APP from the queued APPs to be supplemented to a group of the APPs being packaged on the first set of APP development platforms.

14. The method for integrally implementing development and release of APPs of claim 13, characterized in that,
android development tools which are installed on the APP development platforms perform android packaging operations on the main program templates in advance, so that only the configuration characteristic file modules are to be developed by users; and after the developments are completed, the android development tools perform android packaging operations on the configuration characteristic file modules developed by the users, and finally, results of the two packaging operations are combined to form complete android packaged APPs; and
wherein, only the plist replacement files are to be developed by the users, and after the developments are completed, the plist replacement files replace into the program templates, and then ios packaging operations are performed on the program templates after replacement by utilizing MAC OS systems.

15. The method for integrally implementing development and release of APPs of claim 13, characterized in that, the method further comprises:
developing a new function module in respect to a type of APP templates on an APP development platform;
selecting APPs of this type from released APPs, and packaging the selected APPs with the new function module in re-production of these APPS, and displaying them in gray;
if a user of an APP selects to upgrade it, selecting the APP displayed in gray which is with the new function module; and
if a user of an APP selects not to upgrade it, selecting the APP displayed in normal presentation which is not with the new function module.
